(19) United States
(12) Patent Application Publication
(10) Pub. No.: US 2017/0231414 A1
(43) Pub. Date: Aug. 17, 2017

(54) Slow Juicer

(71) Applicant: NuWave, LLC, Libertyville, IL (US)

(72) Inventors: Jung S. Moon, Long Grove, IL (US); Eunjung Huh, Gurnee, IL (US)

(21) Appl. No.: 15/431,320

(22) Filed: Feb. 13, 2017

Related U.S. Application Data
(60) Provisional application No. 62/294,342, filed on Feb. 12, 2016.

(51) Int. Cl. A47J 19/02

(52) U.S. Cl. CPC A47J 19/02

(57) ABSTRACT

A slow juicer is disclosed including a base having a motor for turning a shaft, a chamber for detachably mounting to the base, a strainer positioned within the chamber, an auger positioned within the strainer and coupled to the shaft, a detachable cover for the chamber, the cover having a hopper positioned atop a feed tube extending from the cover, and a pusher configured to fit within the feed tube, wherein the hopper is sloped toward the feed tube.

### RELATED APPLICATIONS

The present application claims the filing priority of U.S. Provisional Application No. 62/294,342, titled “SLOW JUICER” and filed on Feb. 12, 2016. The '342 Provisional Application is also incorporated herein by reference.

### TECHNICAL FIELD OF THE INVENTION

The present invention relates to juicing machines. Specifically, the invention relates to a slow juicer which is more effective, efficient, and easier to clean.

### BACKGROUND OF THE INVENTION

Juice machines came about around 1930 when a man named Dr. Norman Walker was credited with the first working model. The purpose then, as now, was to help a person obtain the daily recommended servings of fruits and vegetables without necessarily consuming the entirety of the food itself. Dr. Walker presumably understood the health benefits of juicing, as he lived to be 108 years old.

The daily benefits of juicing are numerous and include hydration, increased energy and stamina, replenishing important vitamins (e.g., A, B₁, B₆, C) and minerals (e.g., sodium, calcium, magnesium, iron) into the body. Juicing can be particularly useful for patients who have undergone treatments and drug regiments which have left their bodies depleted of these important and necessary nutrients.

There are also some negatives associated with juicing, especially if not done properly. For example, drinking too much juice can cause problems for those who need to control their blood sugar. Sugars from natural fruits are released into the bloodstream much faster than eating fruit, which can cause spikes in blood sugar. Of course, juices are also going to lack certain proteins which the body needs as well. So, a diet based entirely on juices must be supplemented with protein for a more balanced diet.

A juicer is a mechanical device that can be operated, either manually or electrically, to extract juice from vegetables, fruits and leafy greens. The difference between a juicer and a blender is that a juicer will have some kind of mechanism that will separate the pulp from the juice. Conversely, a blender just grinds the fruits and vegetables together, requiring the pulp to be manually strained or consumed.

With several different types of juicers on the market, e.g., centrifugal, centrifugal ejection, masticating, manual press, single auger, dual cage auger and twin press, it is imperative to understand key factors in selecting a juicer.

While cost of the juicer is an important factor, other factors are more helpful in getting an “apples-to-apples” (or apple juice to apple juice) comparison. The juicer should be user-friendly with easy maintenance and clean up. If a juicer is going to save time, such time should not be spent learning to operate and clean the device. Reliability is also important. Money saved on less expensive models may be lost quickly on replacement parts. Slow speed juicers are more preferred because they have reduced oxidation effects on the fruit. Finally, efficiency of juice extraction is important—i.e., the amount of juice yielded by an amount of food. Some juicers can yield as much undesirable pulp as juice.

Until the invention of the present application, these and other problems in the prior art went either unnoticed or unsolved by those skilled in the art. The present invention provides a slow juicer which performs effectively and efficiently without sacrificing simplicity, design, style or affordability.

### SUMMARY OF THE INVENTION

There is disclosed herein an improved slow juicer which avoids the disadvantages of prior devices while affording additional structural and operating advantages.

Generally speaking, the slow juicer comprises a base having a motor for turning a shaft, a chamber for detachably mounting to the base, a strainer positioned within the chamber, an auger positioned within the strainer and coupled to the shaft, a detachable cover for the chamber, the cover having a hopper positioned atop a feed tube extending from the cover, and a pusher configured to fit within the feed tube, wherein the hopper is sloped toward the feed tube.

In a specific embodiment, the slow juicer comprises a base housing a motor therein, the motor being coupled to a shaft extending through the base at the center of a chamber seat, a chamber defined by a vertical sidewall and detachably mounted on the base at the chamber seat, the chamber having first and second discharge ports, an open upper end, and a bottom surface having an aperture into which the shaft of the base is sealingly admitted and a support wall extending downwardly to engage the chamber seat of the base, a strainer having a mesh sidewall and removably positioned within the chamber directly over at least a portion of the support wall, an auger positioned within the strainer and coupled through the strainer and chamber to the shaft, a frame comprising a spinning brush on an inner surface and a silicone brush on an outer surface, wherein the strainer is positioned within the frame such that during use the frame moves with the auger and the spinning brush engages the strainer to clear the mesh sidewall and the silicone brush engages the sidewall of the chamber, and a detachable cover for the chamber, the cover having a hopper positioned atop a feed tube extending from the cover.

In additional specific embodiments, the base may include a sensor system to prevent operation when the chamber is uncovered. Preferably, the sensor system has a redundancy comprised of two sensing devices in the event one fails.

In an embodiment, the strainer is one of either a fine mesh strainer or a coarse mesh strainer.

In another specific embodiment, the chamber comprises a pulp spout and a juice spout. The juice spout comprises a regulator to somewhat control the flow of juice to prevent it from coming too quickly. The regulator is preferably a mechanism which at least partially and uniformly blocks the opening of the juice spout. The juice spout also preferably comprises a cap for opening and closing the spout.

In another embodiment, the slow juicer includes a redundant safety circuit. The circuit is specifically comprised of a two bidirectional triode thyristors (TRIAC). Should one TRIAC fail, the juicer motor operation will continue as a result of having a second TRIAC in place.

These and other aspects of the invention may be understood more readily from the following description and the appended drawings.

### BRIEF DESCRIPTION OF THE DRAWINGS AND APPENDICES

For the purpose of facilitating an understanding of the subject matter sought to be protected, there are illustrated in the accompanying drawings and attached appendices, embodiments thereof, from an inspection of which, when considered in connection with the following description, the subject matter sought to be protected, its construction and operation, and many of its advantages should be readily understood and appreciated.

FIG. 1 is an exploded view of an embodiment of a slow juicer in accordance with the present disclosure;

FIG. 2 is a perspective view of an assembled embodiment of a slow juicer in accordance with the present disclosure;

FIG. 3 is a perspective view of a disassembled embodiment of the slow juicer shown in FIG. 2;

FIG. 4 is a perspective view of the base showing the position of the concealed safety sensing system;

FIG. 5 is a top view of the base shown in FIG. 4;

FIG. 6 is a perspective view of an embodiment of the slow juicer;

FIG. 7 is front view of the embodiment of the slow juicer shown in FIG. 6;

FIG. 8 is right side view of the embodiment of the slow juicer shown in FIG. 6;

FIG. 9 is left side view of the embodiment of the slow juicer shown in FIG. 6;

FIG. 10 is a side view of an embodiment of a chamber for the disclosed slow juicer;

FIG. 11 is top view of the chamber shown in FIG. 10;

FIG. 12 is bottom view of the chamber shown in FIG. 10;

FIG. 13 is front perspective view of the chamber shown in FIG. 10;

FIGS. 14a and 14b are side views of an embodiment of an auger used in the disclosed juicer;

FIG. 15 is a side view of an embodiment of a cover for the disclosed slow juicer; and

FIG. 16 is a side view of an embodiment of a pusher for the disclosed slow juicer.

### DETAILED DESCRIPTION OF THE INVENTION

While this invention is susceptible of embodiments in many different forms, there is shown in the drawings and will herein be described in detail at least one preferred embodiment of the invention with the understanding that the present disclosure is to be considered as an exemplification of the principles of the invention and is not intended to limit the broad aspect of the invention to any of the specific embodiments illustrated.

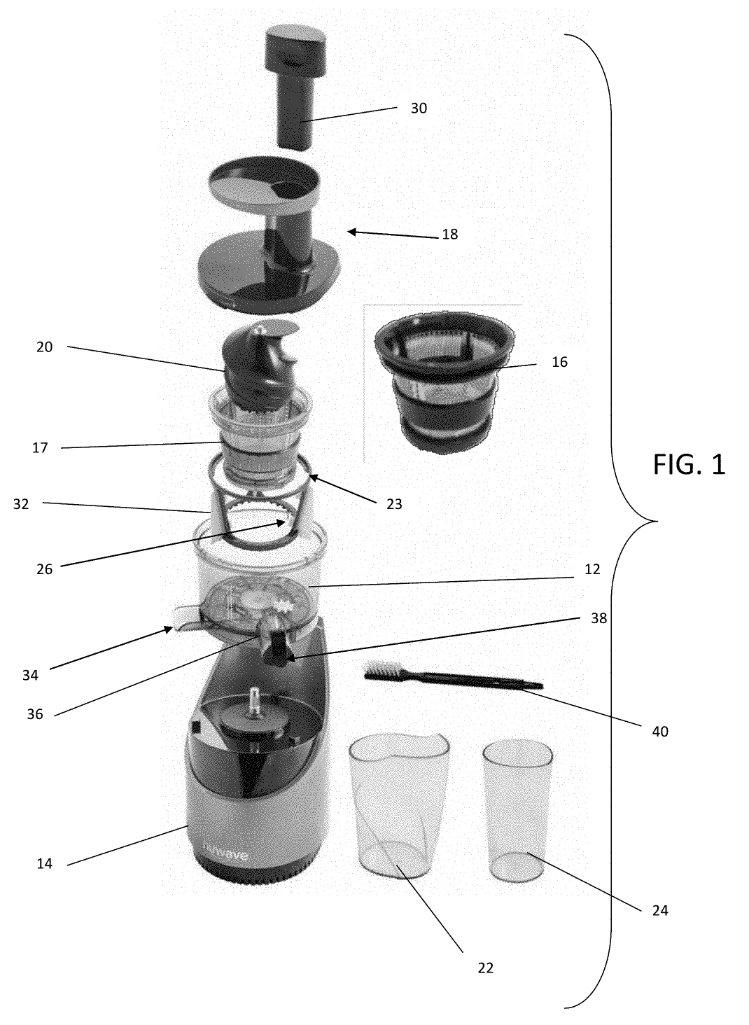

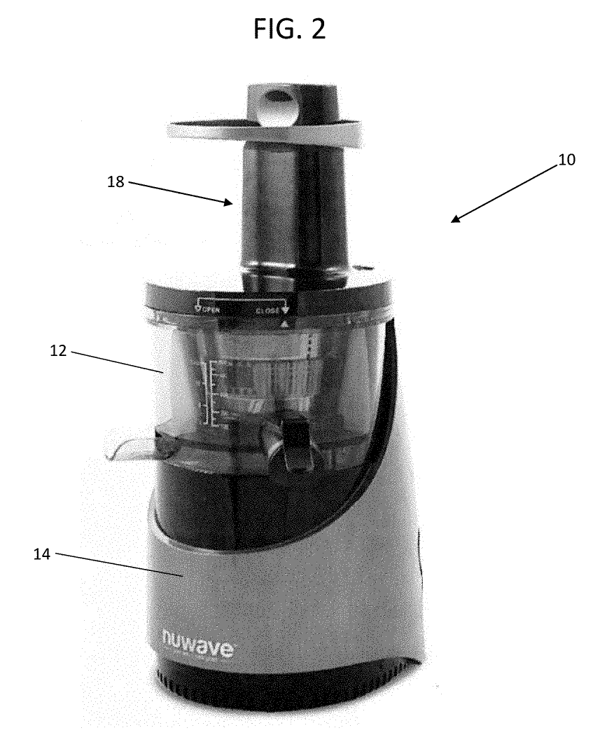

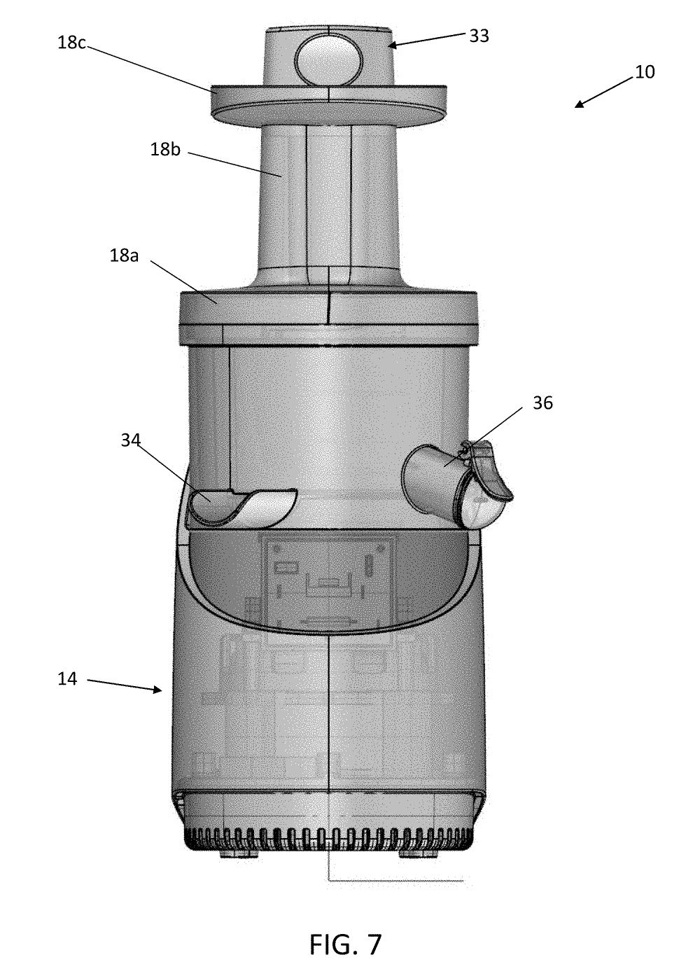

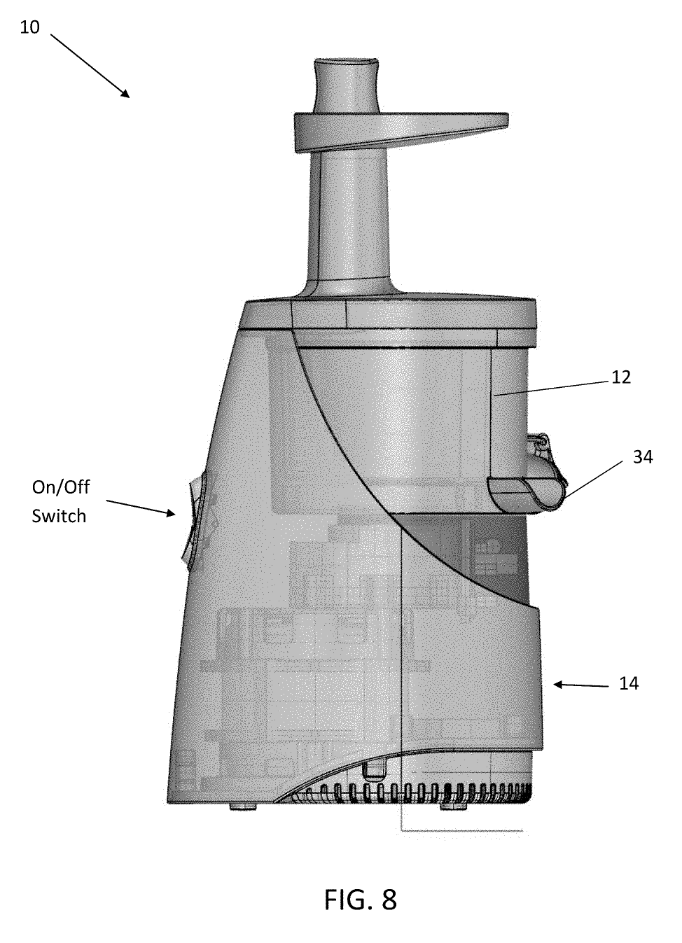

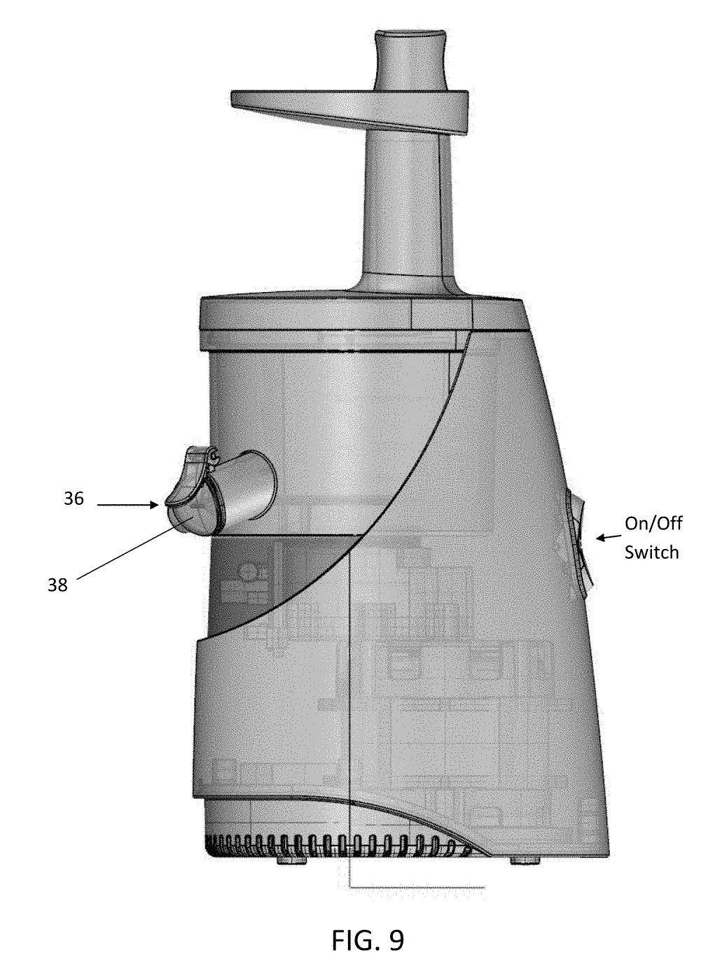

Referring to FIGS. 1-16, there are illustrated embodiments of the present slow juicer, generally designated by the numeral 10, and its various components. The particular illustrated juicer, and all embodiments thereof, is exemplary only. In fact, while any embodiment illustrated may be directed to a specific configuration with specific features, it should be understood that the principles of the invention can be more broadly applied and many of the noted features may be applicable to other embodiments as well.

As can be seen in FIGS. 1-3, the illustrated embodiment of juicer 10 has several components, some of which nest within one another and cannot be seen in all views. Generally, the juicer 10 is comprised of a chamber 12 (aka, a crushing bowl), a base 14, a strainer 16/17 (coarse vs. fine), a cover 18a, including food tube 18b and hopper 18c, and an auger 20. Specific embodiments may also include additional components, such as a pulp container 22, juice container 24, spinning brush 26, pusher 30, silicone brush 32, and a cleaning brush 40. An AC motor (not shown) in the range of 200-300 Watts is housed within the base 14 and couples to the auger 20 via a shaft extending upward.

Not all embodiments will include each of the disclosed components and many of the illustrated components may be modified without deviating from the intended scope of the disclosed invention. Such modifications are considered to fall within the present disclosure as they would be understood by those of skill in the art without more than the details herein.

The juicing process is comprised of three basic stages: (1) food input, (2) food processing, and (3) food discharge. Each of the three stages and the cooperating components of the present slow juicer 10 are described below.

The initial stage of juicing begins with selection and preparation of the foods to be input to the juicer 10. Once properly prepared (e.g., peeling, slicing, etc.), the food can be fed into the juicing chamber 12 through the cover 18a via the food tube 18b. The hopper 18c provides a staging area for placement of prepped food to be subsequently fed into the food tube 18b. This can be accomplished using the food pusher 30 to move food into the tube 18b. The pusher 30 also helps to push food through the tube 18b should it become lodged.

The food tube 18b is preferably a smooth tubular structure without steps or other sharp corners which can collect food particles and inhibit cleaning. Other devices typically include a stepped entry tube at the base of the hopper. Further, the bottom surface of the hopper 18c is sloped toward the entry of the feed tube 18b to facilitate movement of food, including juices into the tube.

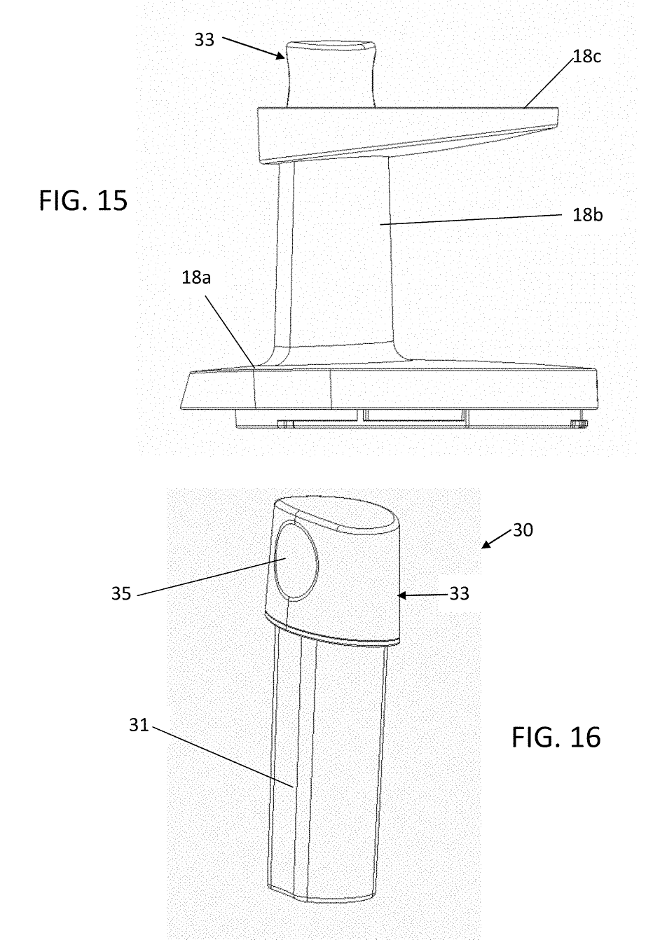

As shown in FIG. 15, the food pusher 30 includes a long tubular body 31 and an ergonomic grip 33. The grip 33 of the food pusher 30 includes a finger rest 35 on each of two opposing sides to facilitate gripping. The configuration of grip 33 also helps ease hand fatigue. The body 31 of the food pusher 30 is configured to fit easily into the food tube 18b to press food into the next stage of the juicing process. However, the length of the body 31 should be less than the distance from the top of the feed tube 18b to the interior of the juicer. This insures that there is no inadvertent contact with the auger 20.

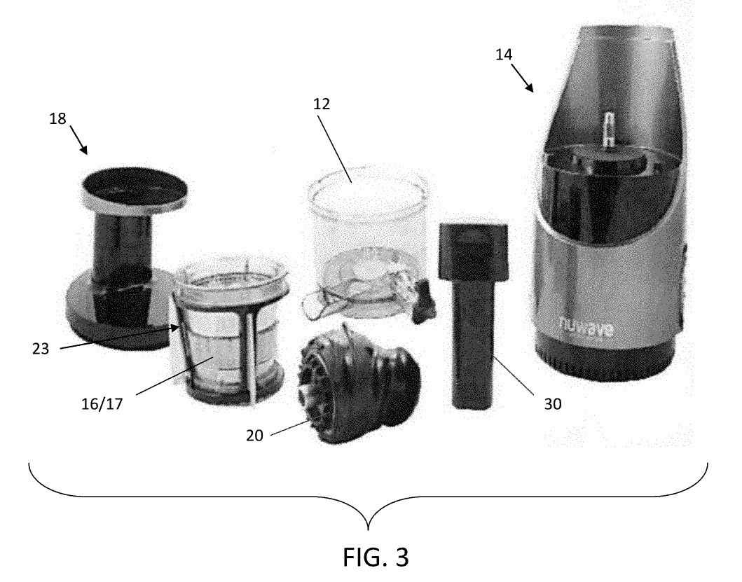

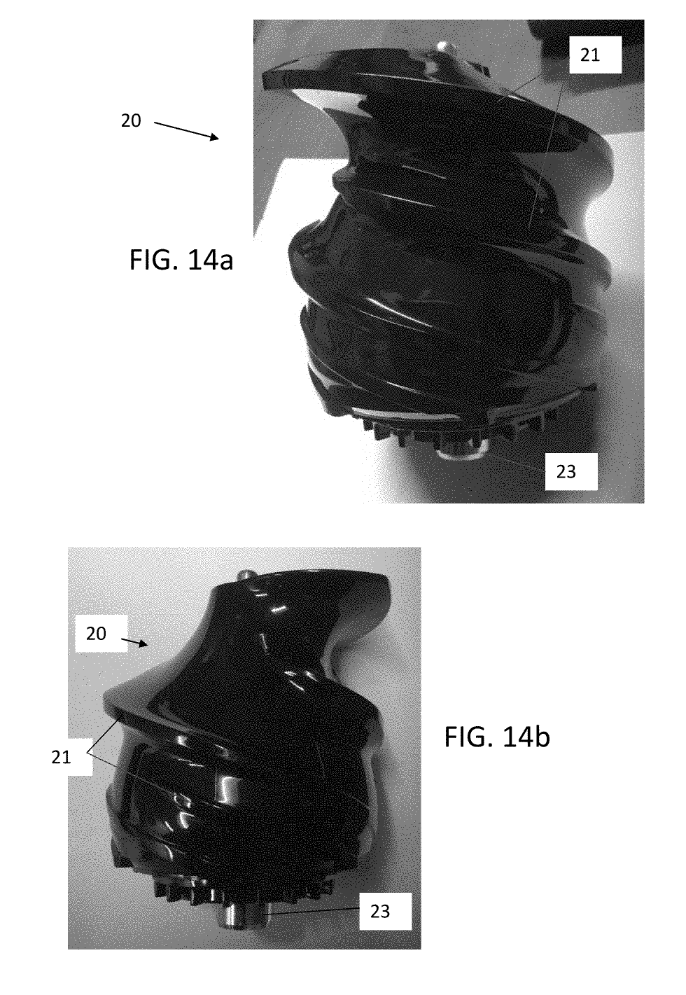

In the second stage, food enters the chamber 12 from the food tube 18b. The food is immediately engaged by a rotating food auger 20. The auger 20, as shown in FIGS. 1 and 3, is positioned at the center of the chamber 12. A preferred embodiment of the auger 20 is shown in FIGS. 14a and 14b. The preferred auger 20 is somewhat “pear-shaped”—flaring outward moving from top to bottom before sloping inward again—and includes at least one aggressive spiraling rib 21 which pulls incoming food downward as it turns. The uppermost edge of the rib 21 is configured for cutting action. The auger 20 has a socket 23 at the bottom to engage the upward extending shaft 42 from the motor (not shown) housed in the base 14. A controller circuit is specifically comprised of two bidirectional triode thyristors (e.g., TRIAC). Should one TRIAC fail, the juicer motor operation will continue as a result of having a second TRIAC in place.

When in use, the auger 20 preferably turns at a rate within the range of about 30-55 rpm, and most preferably within the range of 40-45 rpm. The auger 20 sits within a strainer, either a coarse strainer 16 or a fine strainer 17, and pushes food items outward against the strainer 16/17 as it pulls them downward. The strainer 16/17 has an inverted frustoconical shape such that, as food is pushed downward by the auger rib 13 and outward by the flared body, juice is extracted through the mesh-walled strainer 16/17 to be discharged from the chamber 12.

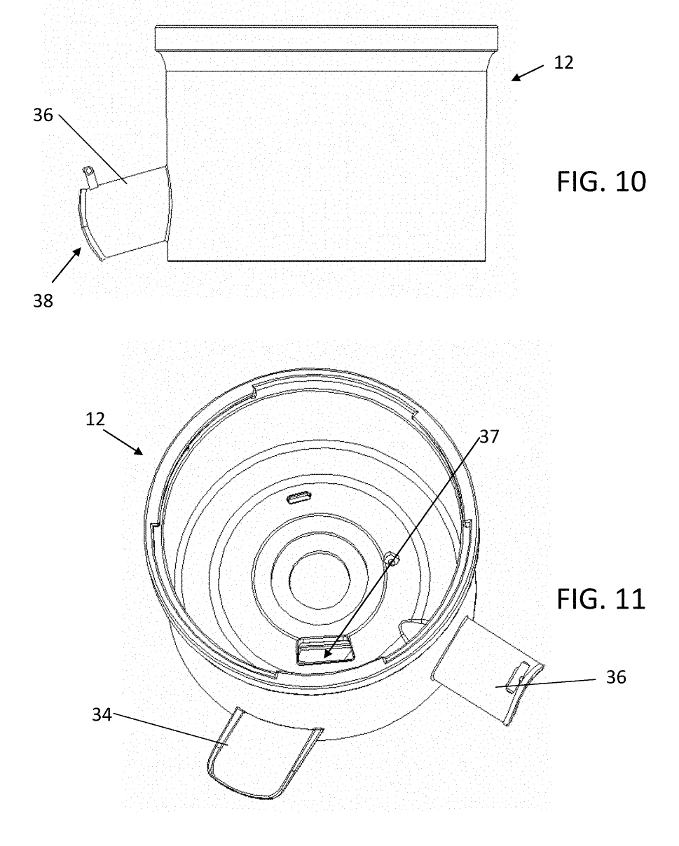

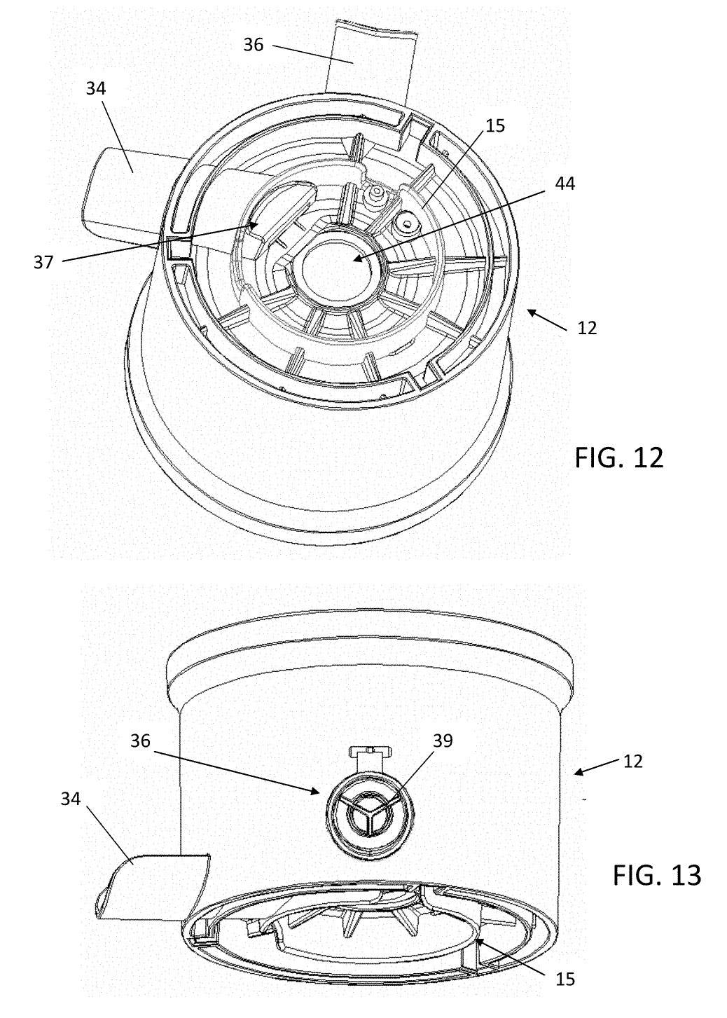

The chamber 12 and its features are best illustrated in FIGS. 10-13. The chamber 12 is most preferably one-piece design comprised of straight, vertical side walls rather than the two-piece sloped or contoured sidewalls of prior art devices which can trap food and inhibit cleaning. An aperture 44 on the bottom surface sealingly mounts the shaft 42 extending from the base 14. The chamber 12 comprises two separate discharge ports extending from the sidewall, including pulp spout 34 and juice spout 36. The pulp spout 34 passes through the sidewall from a central region of the chamber 12 via channel 37, and preferably has an open construction. By “open construction” it is meant that the spout 34 is not a complete cylinder, which can inhibit flow and cause a pulp clog. As shown in FIG. 11, the spout 34 is open on top to better facilitate pulp flow from chamber 12. Conversely, the juice spout 36 is of a cylindrical construction and opens directly through the chamber sidewall. A cap 38 can be provided on the end of the juice spout 36 to control the flow of juice. Additionally, as shown in FIG. 13, a regulator 39 positioned within the juice spout 36 helps control flow of juice as well.

A moving frame 23 is used to keep the extracted food product moving within the juicer 10. The frame 23 includes a spinning brush 26 attached to an inner surface of the frame to engage the mesh sidewall of the strainer 16/17, and a silicone brush 32 on an outer surface of the frame to engage the interior of the chamber sidewall. The frame 23 preferably moves with the auger 20, while the strainer 16/17 remains stationary. Accordingly, as juice is extracted from the food, it passes through the strainer 16/17 and is moved to the juice spout 36 by silicone brush 32. The exterior wall of the strainer 16/17 is contacted by spinning brush 26 to do the same. Conversely, the pulp and food waste is discharged through an opening in the bottom of the strainer 16/17 to enter the channel 37 leading to pulp spout 34.

The chamber 12 has another unique feature illustrated in FIG. 12. A circular support wall 15 positioned on the underside of the chamber 12 has a diameter equal to the strainer 16/17. As force is exerted downward on the strainer 16/17 from the auger 20 and the pushing of food into the chamber 12, the support wall 15 prevents the strainer 16/17 from moving down as well, thereby preventing the leakage of pulp into the juice stream. The resulting quality of juice is improved as a result.

The third stage of the juicing process is the discharge and collection of the final product. As explained above, the juice passes through the strainer 16/17 and flows from the chamber into the juice spout 36. Pulp and other wastes are discharged from the pulp spout 34. In specific embodiments, a pulp container 22 can be positioned just under the pulp spout 34 to catch discharged pulp. Likewise, juice container 24 can be provided and positioned under the juice spout 36 to collect expelled juice.

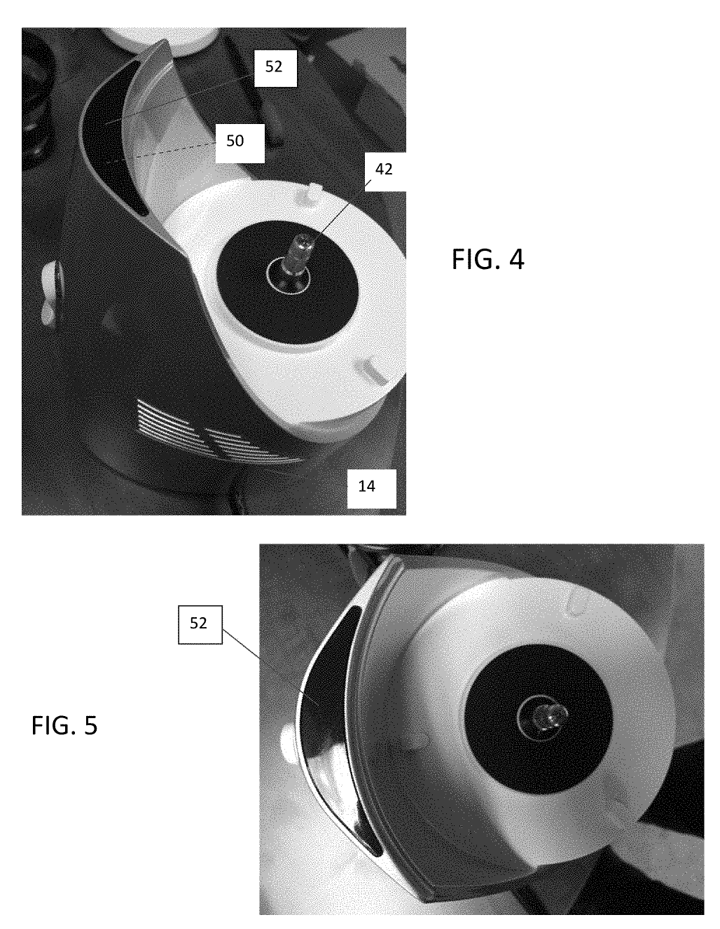

FIGS. 4 and 5 illustrate an embodiment of the base 14 in which a safety sensing system 50 is provided. The sensing system 50 preferably includes a transparent surface 52 with at least two sensors (not shown) housed just under the surface 52 as part of a circuit. The cover 18 is designed to block the surface 52 when seated properly, thereby signaling to the sensors that the cover 18 is attached. This will allow operation of the juicer 10. If the cover 18 is not positioned on the chamber 12 properly, the sensing system 50 will then prevent operation. The use of two sensors provides a redundancy in the event that one sensor fails.

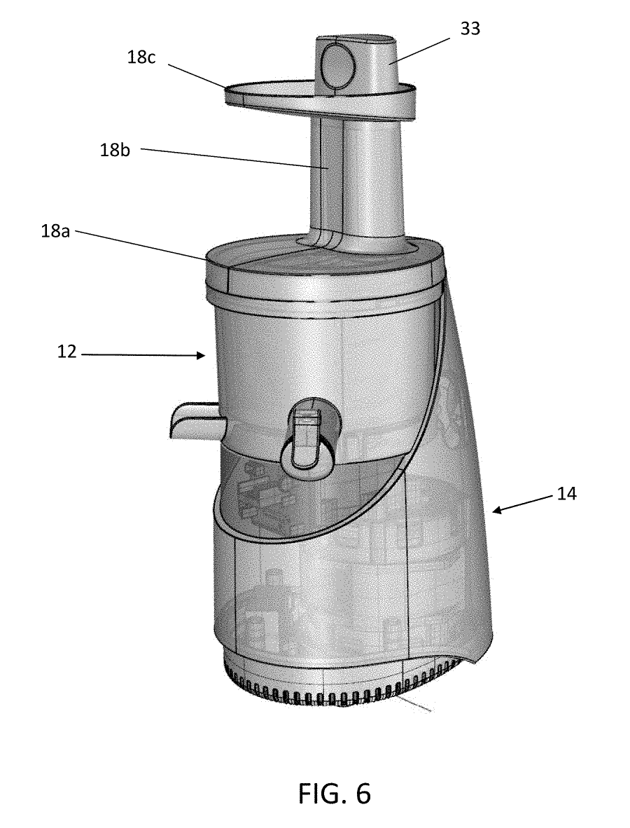

FIGS. 6-9 are renderings of an embodiment of the assembled slow juicer 10, showing the sleek design. The chamber 12, base 14, and cover 18 are intended to transition smoothly from one to another. Even the food tube 18b and hopper 18c are intended to present a smooth profile for the juicer 10. These features, while aesthetically pleasing, also facilitate cleaning by limiting crevices, nooks and corners where food product may get caught up.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A slow juicer comprising:
a base housing a motor therein, the motor being coupled to a shaft extending through the base at the center of a chamber seat;
a chamber defined by a vertical sidewall and detachably mounted on the base at the chamber seat, the chamber having first and second discharge ports, an open upper end, and a bottom surface having an aperture into which the shaft of the base is sealingly admitted and a support wall extending downwardly to engage the chamber seat of the base;
a strainer having a mesh sidewall and removably positioned within the chamber directly over at least a portion of the support wall;
an auger positioned within the strainer and coupled through the strainer and chamber to the shaft; and
a detachable cover for the chamber, the cover having a hopper positioned atop a feed tube extending from the cover;
wherein the hopper is sloped toward the feed tube.

2. The slow juicer of claim 1, wherein the strainer is one of either a fine mesh strainer or a coarse mesh strainer.

3. The slow juicer of claim 1, wherein the second discharge port connects to a channel within the chamber which opens on the bottom surface of the chamber proximate a center.

4. The slow juicer of claim 3, wherein the juice spout comprises a regulator to control juice flow.

5. The slow juicer of claim 4, wherein the juice spout further comprises a cap for opening and closing the spout.

6. The slow juicer of claim 3, wherein the pulp spout is open on at least one side as it exits the chamber.

7. The slow juicer of claim 1, further comprising a spinning brush and silicone brush attached on opposite sides of a frame into which the strainer is positioned such that during use the spinning brush engages the strainer to clear the mesh sidewall and the silicone brush engages the sidewall of the chamber.

8. The slow juicer of claim 1, further comprising a safety sensing system housed within the base.

9. The slow juicer of claim 8, wherein the sensing system comprises a redundancy of at least two sensors.

10. A slow juicer comprising:
a base housing a motor therein, the motor being coupled to a shaft extending through the base at the center of a chamber seat;
a chamber defined by a vertical sidewall and detachably mounted on the base at the chamber seat, the chamber having first and second discharge ports, an open upper end, and a bottom surface having an aperture into which the shaft of the base is sealingly admitted and a support wall extending downwardly to engage the chamber seat of the base;
a strainer having a mesh sidewall and removably positioned within the chamber directly over at least a portion of the support wall;
an auger positioned within the strainer and coupled through the strainer and chamber to the shaft;
a frame comprising a spinning brush on an inner surface and a silicone brush on an outer surface, wherein the strainer is positioned within the frame such that during use the frame moves with the auger and the spinning brush engages the strainer to clear the mesh sidewall and the silicone brush engages the sidewall of the chamber; and
a detachable cover for the chamber, the cover having a hopper positioned atop a feed tube extending from the cover;
wherein the hopper is sloped toward the feed tube.

11. The slow juicer of claim 10, wherein the strainer is one of either a fine mesh strainer or a coarse mesh strainer.

12. The slow juicer of claim 10, wherein the second discharge port connects to a channel within the chamber which opens on the bottom surface of the chamber proximate a center.

13. The slow juicer of claim 12, wherein the juice spout comprises a regulator to control juice flow.

14. The slow juicer of claim 10, further comprising a safety sensing system housed within the base.

15. The slow juicer of claim 14, wherein the sensing system comprises a redundancy of at least two sensors.
